(19) United States
(12) Patent Application Publication
(10) Pub. No.: US 2026/0210324 A1
(43) Pub. Date: Jul. 23, 2026

(54) POWER GENERATION SYSTEM AND ENERGY STORAGE SYSTEM

(71) Applicant: NTT, Inc, Tokyo (JP)

(72) Inventors: Yosuke TAKEUCHI, Tokyo (JP); Akira ITO, Tokyo (JP); Ryo MAKINO, Tokyo (JP); Junichiro TAMAMATSU, Tokyo (JP)

(73) Assignee: NTT, Inc., Tokyo (JP)

(21) Appl. No.: 19/140,271

(22) PCT Filed: Dec. 27, 2022
(86) PCT No.: PCT/JP2022/048417

§ 371 Date: Jun. 17, 2025

(51) Int. Cl. F03B 13/06; H02J 3/32

(52) U.S. Cl. CPC F03B 13/06; H02J 3/32

(57) ABSTRACT

A power generation system (10) according to the present disclosure includes: the first underground structure (121) provided in an underground (A) and defining an internal space (IS) ; a water discharge controller (123) that controls discharge of water (wt) retained in the internal space (IS) ; and a power generation unit (124) disposed at a position where the water (wt) is retained in the internal space (IS) or a pipeline (127) communicating with the internal space (IS), the power generation unit (124) generates electric energy from hydraulic energy generated by discharge of the water (wt).

### TECHNICAL FIELD

The present disclosure relates to a power generation system and an energy storage system.

### BACKGROUND ART

Conventionally, hydraulic power generation is known to be a large-scale energy storage technology capable of storing energy with the highest efficiency (see Non Patent Literature 1). In addition, since the environmental load and the investment cost generated with the construction of a large-scale power generation facility for using the large-scale energy storage technology are large, a small hydraulic power generation technology using water of a river has attracted attention (see Non Patent Literatures 2 and 3).

### CITATION LIST

### Non Patent Literature

Non Patent Literature 1:“Small and Micro-Scale Hydropower in Japan: Potential, Incentives and Regulation”, [online], [Searched on December 21, 2022], the Internet <https://shs.hal.science/halshs-01803429/document>, Yveline Lecler, Emeritus Professor, University of Lyon, Sciences-Po Lyon and Institute of East Asian Studies
Non Patent Literature 2: Brett Dolter, and two others, The cost effectiveness of new reservoir hydroelectricity: British Columbia's Site C project, Energy Policy 169 (2022) 113161
Non Patent Literature 3: Alvaro Espinel, and two others, “Distributed electrical resources with micro hydroelectric power plants in Colombia-Study case”, The 4th International Conference on Electrical Engineering and Green Energy CEEGE 2021, 10-13 June, Munich, Germany
Non Patent Literature 4: “Shosuryokuhatuden Secchi No Tame No Tebiki (in Japanese) (Guide for Small Hydropower Generation Installation)”, [online], [Searched on December 21, 2022], the Internet <https:/www.mlit.co.jp/river/riyou/syosuiryoku/pdf/syousui ryoku_tebiki3.pdf>The Ministry of Land, Infrastructure, Transport and Tourism, Water and Disaster Management Bureau

### SUMMARY OF INVENTION

### Technical Problem

However, in Japan, in order to use water of a river, registration or permission to the Ministry of Land, Infrastructure, Transport and Tourism is required, and dependent power generation using a water reduction section and power generation using water newly taken from the river may be difficult.

An object of the present disclosure made in view of such circumstances is to provide a power generation system and an energy storage system that can be configured without using water of a river by suppressing environmental load and cost.

### Solution to Problem

In order to solve the above problems, a power generation system according to the present disclosure includes: the first underground structure provided in an underground and defining an internal space; a water discharge controller that controls discharge of water retained in the internal space; and a power generation unit disposed at a position where the water is retained in the internal space or a pipeline communicating with the internal space, the power generation unit generates electric energy from hydraulic energy generated by discharge of the water.

In addition, in order to solve the above problems, an energy storage system according to the present disclosure includes a power generation system and an energy storage device. The power generation system includes: the first underground structure provided in an underground and defining an internal space; a water discharge controller that controls discharge of water retained in the internal space; and a power generation unit disposed at a position where the water is retained in the internal space or a pipeline communicating with the internal space, the power generation unit generates electric energy from hydraulic energy generated by discharge of the water. The energy storage device stores the electric energy generated by the power generation unit.

### Advantageous Effects of Invention

A power generation system and an energy storage system according to the present disclosure can be configured without using water of a river by suppressing environmental load and cost.

### BRIEF DESCRIPTION OF DRAWINGS

FIG. 1 is a block diagram illustrating an example of an energy storage system according to the first embodiment of the present disclosure.

FIG. 2 is a schematic diagram illustrating an example of the energy storage system illustrated in FIG. 1.

FIG. 3 is a view for explaining an aspect in which a water storage unit illustrated in FIG. 1 is provided underground.

FIG. 4 is a diagram illustrating an example of the water storage unit illustrated in FIG. 2 in detail.

FIG. 5 is a flowchart illustrating an example of an operation executed by a power generation system illustrated in FIG. 1.

FIG. 6 is a block diagram illustrating an example of an energy storage system according to the second embodiment of the present disclosure.

FIG. 7 is a schematic diagram illustrating an example of the energy storage system illustrated in FIG. 6.

FIG. 8 is a hardware block diagram of an operation instruction unit.

### DESCRIPTION OF EMBODIMENTS

### First Embodiment

An energy storage system 100 of the first embodiment will be described with reference to the drawings.

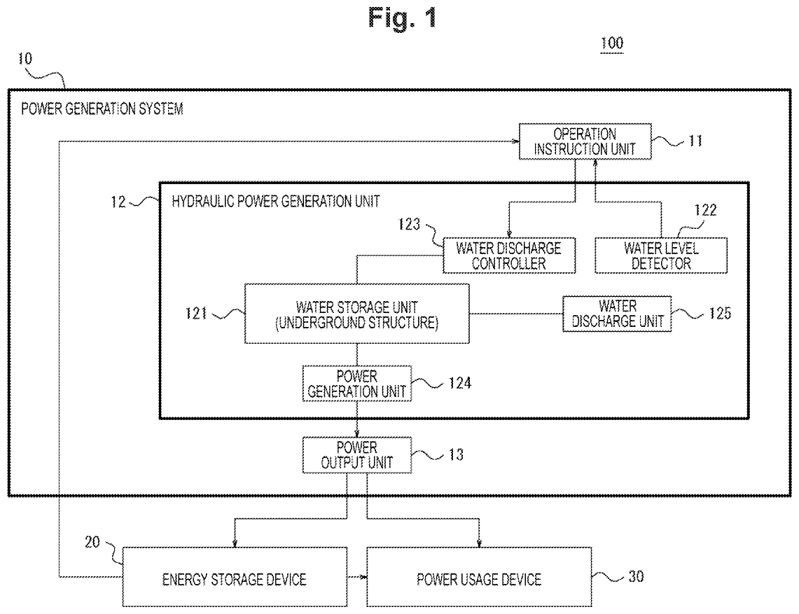

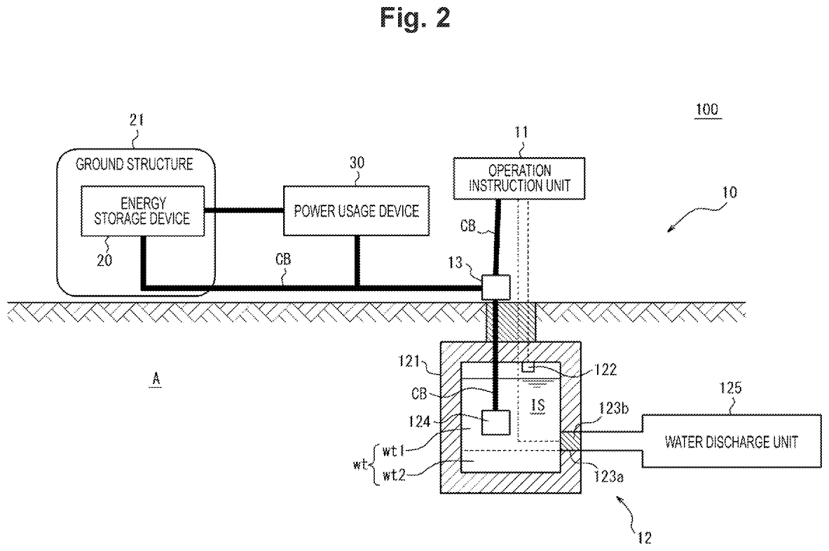

As illustrated in FIGS. 1 and 2, the energy storage system 100 includes a power generation system 10 and an energy storage device 20. The energy storage system 100 may further include a power usage device 30.

<Configuration of Power Generation System>The power generation system 10 includes an operation instruction unit 11, a hydraulic power generation unit 12, and a power output unit 13.

The operation instruction unit 11 includes controller. The controller may include dedicated hardware such as an application specific integrated circuit (ASIC) or a field-programmable gate array (FPGA), may include a processor, or may include both the dedicated hardware and the processor.

The operation instruction unit 11 may determine whether or not a water level of water retained in a water storage unit 121 to be described in detail later is equal to or higher than a water level threshold. Specifically, the operation instruction unit 11 may receive water level information indicating a water level from a water level detector 122 to be described in detail later, and determine whether or not the water level indicated by the water level information is equal to or higher than the water level threshold. In addition, the operation instruction unit 11 may receive, from the water level detector 122, water level information indicating whether or not the water level is equal to or higher than the water level threshold, and determine whether or not the water level is equal to or higher than the water level threshold based on the water level information.

Then, if it is determined that the water level is equal to or higher than the water level threshold, the operation instruction unit 11 transmits, to a water discharge controller 123 to be described in detail later, water discharge command for discharging water from the water storage unit 121. If it is determined that the water level is lower than the water level threshold, the operation instruction unit 11 transmits, to the water discharge controller 123, a water discharge stop command for preventing water from being discharged from the water storage unit 121.

Furthermore, the operation instruction unit 11 may determine whether or not the electric energy amount, which is the amount of electric energy generated by a power generation unit 124, is increased when the water discharge controller 123 is causing water to be discharged from the water storage unit 121. Specifically, the operation instruction unit 11 may receive electric energy information indicating a change in the amount of energy stored in the energy storage device 20, and determine whether or not the energy amount is increased based on the change in the energy amount indicated by the energy information.

Then, if it is determined that the energy amount is increased, the operation instruction unit 11 transmits a water discharge command to the water discharge controller 123. In addition, if it is determined that the energy amount is not increased, the operation instruction unit 11 transmits a water discharge stop command to the water discharge controller 123.

The hydraulic power generation unit 12 includes the water storage unit (underground structure (first underground structure)) 121, the water level detector 122, the water discharge controller 123, and the power generation unit 124. The hydraulic power generation unit 12 may further include a water discharge unit 125.

The water storage unit 121 is an underground structure that is provided in an underground A and defines an internal space IS. The water storage unit 121 is, for example, a manhole.

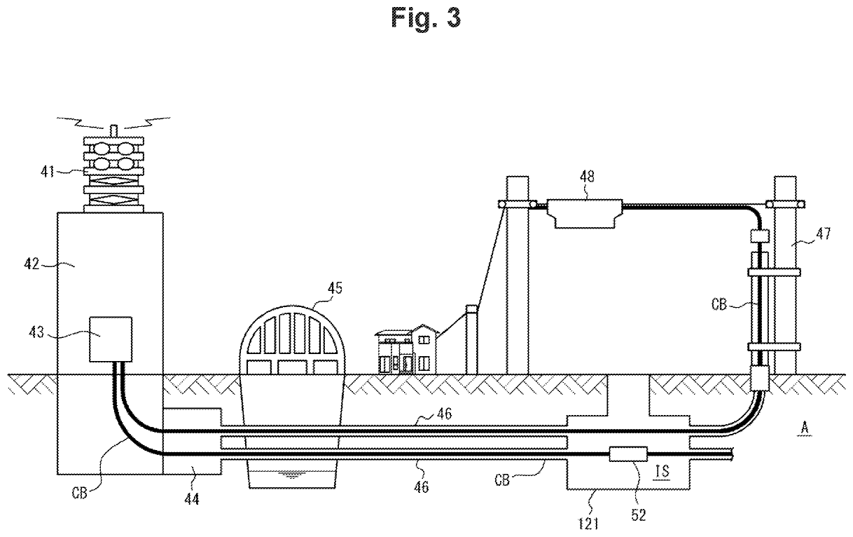

As illustrated in FIG. 3, a part of a cable CB such as a communication cable is accommodated in the water storage unit 121. The cable CB extends from a communication facility 43 accommodated in a communication office building 42, which is a building including a steel tower 41, through a cable tunnel 44 under the underground A, under a bridge 45, a pipeline 46, the water storage unit 121 (in this example, the manhole), and the like, and further supported by a utility pole 47 on the ground, and is accommodated in a terminal box 48.

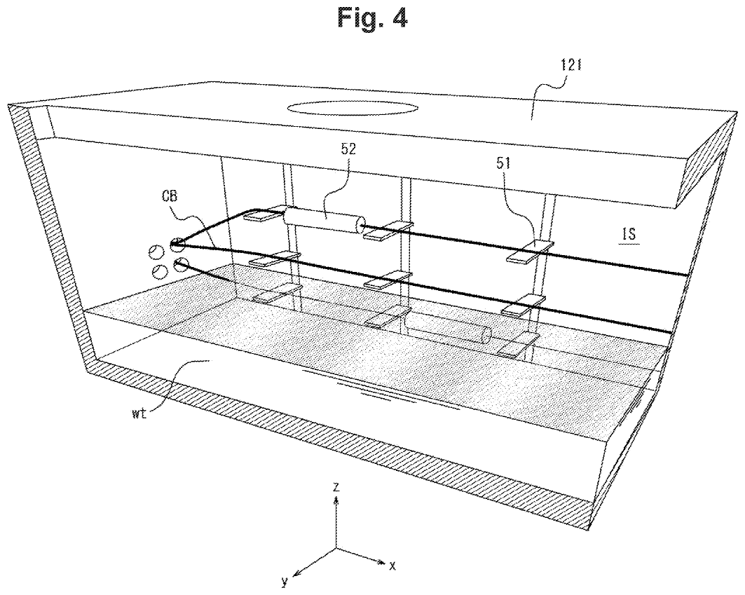

As illustrated in FIG. 4, the cable CB may be supported by a distribution member 51 in the internal space IS of the water storage unit 121. In addition, a terminal box 52 may be provided in the internal space IS and a part of the cable CB may be accommodated in the terminal box 52. Note that, the members provided in the internal space IS is not limited to these examples, and any member according to the use of the water storage unit 121 may be provided in the internal space is.

In some cases, water wt contained in the ground such as rainwater intrudes into the water storage unit 121 illustrated in FIGS. 1 and 2 for some reason, whereby the water wt is retained in the internal space IS of the water storage unit 121. In particular, the water wt is often retained in the internal space IS of the water storage unit 121 provided in the underground A at a low altitude.

The water level detector 122 includes a water level detection sensor. The water level detector 122 detects the water level of the water wt retained in the water storage unit 121. In such a configuration, the water level detector 122 transmits water level information indicating the detected water level to the operation instruction unit 11. In addition, the water level detector 122 may detect whether or not the water level of the water wt is equal to or higher than the water level threshold. In such a configuration, the water level detector 122 transmits, to the operation instruction unit 11, water level information indicating whether or not the water level of the water wt is equal to or higher than the water level threshold.

The water discharge controller 123 includes a water discharge facility, and controls discharge of the water wt retained in the water storage unit 121. As illustrated in FIG. 2, the water discharge controller 123 may include a drain port 123a that allows the internal space IS of the water storage unit 121 to communicate with the outside, and a closing member 123b that closes the drain port 123a. The closing member 123b can be a plug, a valve, a cap, or the like. In addition, the water discharge controller 123 may include a pump.

As an example, when receiving the water discharge command from the operation instruction unit 11, the water discharge controller 123 causes the water wt to be discharged from the water storage unit 121. In addition, when receiving the water discharge stop command from the operation instruction unit 11, the water discharge controller 123 prevents the water wt from being discharged from the water storage unit 121.

Specifically, based on the water discharge command output from the operation instruction unit 11, the water discharge controller 123 may cause the closing member 123b to be removed from the drain port 123a by an arbitrary mechanism and cause the water wt to be discharged from the water storage unit 121. In addition, based on the water discharge stop command output from the operation instruction unit 11, the water discharge controller 123 may cause the closing member 123b to be attached to the drain port 123a by the mechanism, and prevent the water wt from being discharged from the water storage unit 121.

In addition, based on the water discharge command output from the operation instruction unit 11, the water discharge controller 123 may cause the water wt to be discharged from the water storage unit 121 by the operation of the pump. In addition, based on the water discharge stop command output from the operation instruction unit 11, the water discharge controller 123 may prevent the water wt from being discharged from the water storage unit 121 by stopping the operation of the pump.

As another example, based on the operation of an operator, the water discharge controller 123 controls discharge of the water wt retained in the water storage unit 121. Specifically, the closing member 123b is removed from the drain port 123a by the operator, whereby the water discharge controller 123 causes the water wt to be discharged from the water storage unit 121. In addition, the closing member 123b is attached to the drain port 123a by the operator, whereby the water discharge controller 123 prevents the water wt from being discharged from the water Storage unit 121. Note that, as described above, in the configuration in which the discharge of water wt is controlled based on the operation of the operator, the power generation system 10 does not need to include the operation instruction unit 11.

The power generation unit 124 includes a generator having a hydraulic turbine or the like. The power generation unit 124 is disposed at a position where the water wt is retained in the internal space IS of the water storage unit 121. The power generation unit 124 generates electric energy from hydraulic energy. Specifically, the power generation unit 124 converts kinetic energy of the water wt into mechanical energy by receiving water pressure and rotating. Then, the power generation unit 124 generates electric energy by converting the mechanical energy. In this manner, the power generation unit 124 can generate electric energy from hydraulic energy associated with a water flow generated by discharge of the water wt from the water storage unit 121 under the control of the water discharge controller 123.

The water discharge unit 125 is formed of, for example, a hollow concrete structure. The water discharge unit 125 accommodates the water wt discharged from the water storage unit 121 by the water discharge controller 123. The electric energy amount generated by the power generation unit 124 increases as the amount of the water wt discharged from the water storage unit 121 to the water discharge unit 125 increases. The amount of the water wt discharged from the water storage unit 121 to the water discharge unit 125 depends on the amount of movable retention water wt1 in the water storage unit 121, the amount of the water wt retained in the pipeline to the water discharge unit 125, and the capacity of the water discharge unit 125. Therefore, the capacity of the water discharge unit 125 may be appropriately designed based on the total amount of the maximum amount of the movable retention water wt1 and the maximum amount of the water wt retained in the pipeline to the water discharge unit 125 according to the desired electric energy amount. The movable retention water wt1 is water that can be discharged through a pipeline out of the water wt retained in the water storage unit 121, and is water retained above the lower surface of the drain port 123a. Immovable retention water wt2 is water retained below the lower surface of the drain port 123a out of the water wt retained in the water storage unit 121.

Note that, the hydraulic power generation unit 12 does not need to include the water discharge unit 125, and in such a configuration, the water wt discharged from the water storage unit 121 may be discharged to an arbitrary structure provided outside the power generation system 10. In addition, the water wt discharged from the water storage unit 121 may be discharged to a region where no structure is provided in the underground A. In this case, it is preferable that the soil included in the region has a soil property with good drainage. In addition, the soil included in the region may be reformed to soil with good drainage. As a result, the water discharge efficiency from the water storage unit 121 is improved. In addition, the water wt discharged from the water storage unit 121 may be discharged from the water storage unit 121 to a river, the sea, farmland, and the like.

The power output unit 13 includes a power output terminal. The power output unit 13 outputs the power generated by the power generation unit 124 and propagated through the cable CB. The cable CB may be a communication cable or a power cable already provided in the water storage unit 121, or may be a newly provided power cable.

The power output unit 13 can output the electric energy generated by the power generation unit 124 to the energy storage device 20. In addition, the power output unit 13 can output the electric energy generated by the power generation unit 124 to the power usage device 30.

The energy storage device 20 can store the electric energy generated by the power generation unit 124. The energy storage device 20 may be any storage battery, or may be a fuel cell that stores electric energy as hydrogen energy. The energy storage device 20 may be accommodated in a ground structure 21 provided on the ground.

In addition, the energy storage device 20 may detect the electric energy amount which is the amount of electric energy generated by the power generation unit 124. In addition, the energy storage device 20 may transmit, to the operation instruction unit 11, electric energy amount information indicating the electric energy amount. In addition, the energy storage device 20 may also output the electric energy to the power usage device 30.

The power usage device 30 is a device that operates using electric energy. The power usage device 30 can be a lighting device, a communication device, or the like, but is not limited thereto. The power usage device 30 may operate using the electric energy output from the power output unit 13 or may operate using the electric energy output from the energy storage device 20.

### <Operation of Power Generation System>

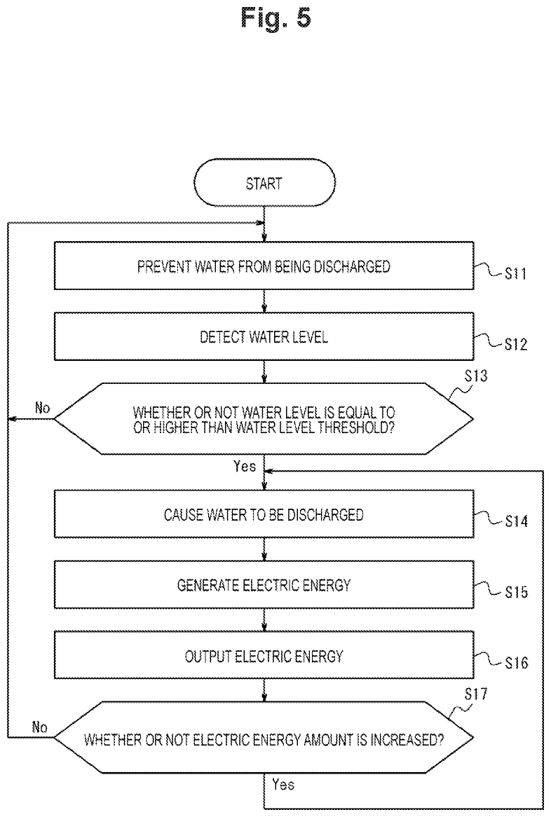

Here, an operation of the power generation system 10 according to the first embodiment will be described with reference to FIG. 5. FIG. 5 is a flowchart illustrating an example of the operation of the power generation system 10 according to the first embodiment. The operation in the power generation system 10 described with reference to FIG. 5 corresponds to an example of a determination method executed by the power generation system 10 according to the first embodiment.

In step S11, the water discharge controller 123 prevents the water wt from being discharged from the water storage unit 121. As a result, the water wt contained in the ground such as rainwater intrudes into the internal space IS of the water storage unit 121 for some reason, whereby the water wt is retained in the internal space IS.

In step S12, the water level detector 122 detects the water level of the water wt retained in the water storage unit 121.

In step S13, the operation instruction unit 11 determines whether or not the water level is equal to or higher than the water level threshold.

If it is determined in step S13 that the water level is lower than the water level threshold, the water discharge controller 123 prevents the water wt from being discharged from the water storage unit 121, the process returns to step S11, and the power generation system 10 repeats the processing.

If it is determined in step S13 that the water level is equal to or higher than the water level threshold, the water discharge controller 123 causes the water wt to be discharged from the water storage unit 121 in step S14.

In step S15, the power generation unit 124 generates electric energy from hydraulic energy.

In step S16, the power output unit 13 outputs the electric energy generated by the power generation unit 124.

In step S17, the operation instruction unit 11 determines whether or not the electric energy amount, which is the amount of electric energy generated by the power generation unit 124, is increased.

If it is determined in step S17 that the energy amount is increased, the process returns to step S14, and the water discharge controller 123 continues to cause the water wt to be discharged from the water storage unit 121.

If it is determined in step S17 that the energy amount is not increased, the process returns to step S11, and the water discharge controller 123 prevents the water wt from being discharged from the water storage unit 121.

As described above, the power generation system 10 according to the first embodiment includes the water storage unit 121 that is provided in the underground A and defines the internal space IS, the water discharge controller 123 that controls discharge of the water wt retained in the internal space IS, and the power generation unit 124 that is disposed at a position where the water wt is retained in the internal space IS and generates electric energy from hydraulic energy generated by discharge of the water wt. As a result, the power generation system 10 can be configured without using water of a river by suppressing environmental load and cost. In addition, in a case where an existing manhole or the like is used as the water storage unit 121, the power generation system 10 can be easily configured as compared with a case where the water storage unit 121 is newly provided.

In addition, the power generation system 10 according to the first embodiment further includes: the water level detector 122 that detects the water level of the water wt retained in the water storage unit 121; and the operation instruction unit 11 that determines whether or not the water level is equal to or higher than the water level threshold, transmits, to the water discharge controller 123, a water discharge command for discharging the water wt from the water storage unit 121 if it is determined that the water level is equal to or higher than the water level threshold, and transmits, to the water discharge controller 123, a water discharge stop command for preventing the water wt from being discharged from the water storage unit 121 if it is determined that the water level is lower than the water level threshold. The water discharge controller 123 causes the water wt to be discharged from the water storage unit 121 when receiving the water discharge command, and prevents the water wt from being discharged from the water storage unit 121 when receiving the water discharge stop command. As a result, the power generation system 10 can retain the water wt in the water storage unit 121 so as to generate a water flow required for the power generation unit 124 to generate power, and furthermore, can suppress retention of the water wt in the water storage unit 121 so that the water wt is spouted out by pushing up a member (for example, an iron lid) that closes the opening for communicating with the ground in the water storage unit 121. Furthermore, the power generation system 10 can control the discharge of water wt without an operator performing an operation. At this time, electric energy is used for transmission of the water discharge command and the water discharge stop command by the operation instruction unit 11, but this is useful in a case where larger electric energy is generated by the power generation unit 124.

In addition, in the power generation system 10 according to the first embodiment, the operation instruction unit 11 determines whether or not the electric energy amount, which is the amount of electric energy generated by the power generation unit 124, is increased when the water discharge controller 123 causes the water wt to be discharged from the water storage unit 121, and transmits a water discharge command to the water discharge controller 123 if it is determined that the electric energy amount is increased, and transmits a water discharge stop command to the water discharge controller 123 if it is determined that the electric energy amount is not increased. As a result, when the electric energy amount is not increased, that is, when the water flow required for the power generation unit 124 to generate power is not generated, the water discharge controller 123 can retain the water wt so that the power generation unit 124 can generate power without discharging the water wt from the water storage unit 121.

In the power generation system according to the first embodiment, the water discharge controller 123 causes the water wt to be discharged from the water storage unit 121 by removal of the closing member 123b from the drain port 123a, and prevents the water wt from being discharged from the water storage unit 121 by attachment of the closing member 123b to the drain port 123a. As a result, for example, when the closing member 123b is removed from the drain port 123a by the operator, the power generation system 10 can discharge the water wt from the water storage unit 121 without using electric power, so that the power saving effect is improved. even when a power failure occurs due to a disaster or the like, the power generation system 10 can discharge the water wt from the water storage unit 121 and generate electric energy.

### Second Embodiment

An energy storage system 100-1 according to the second embodiment will be described with reference to the drawings. In the second embodiment, the same functional units as those in the first embodiment are denoted by the same reference signs, and the description thereof will not be repeated.

The energy storage system 100-1 includes a power generation system 10-1 and the energy storage device 20.

The energy storage system 100-1 may further include the power usage device 30.

### <Configuration of Power Generation System>

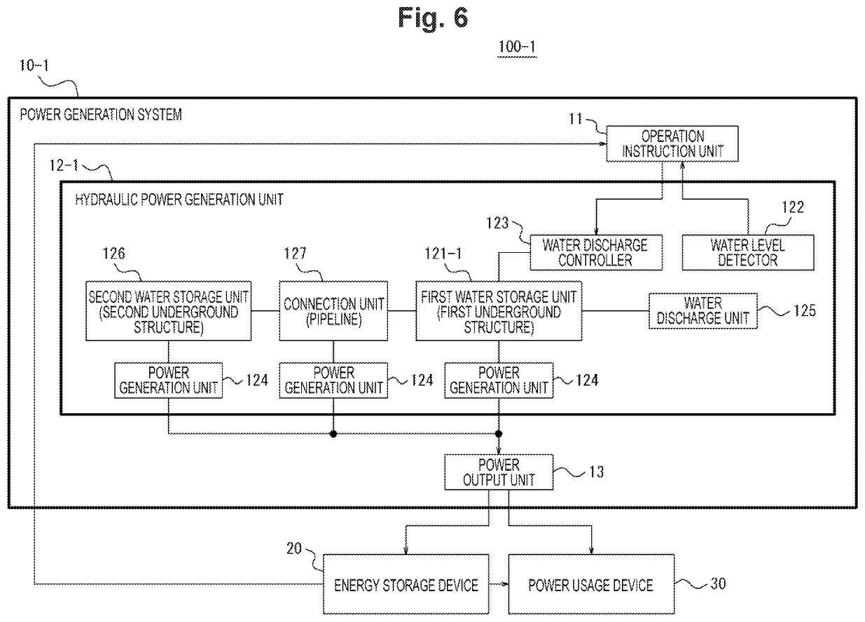

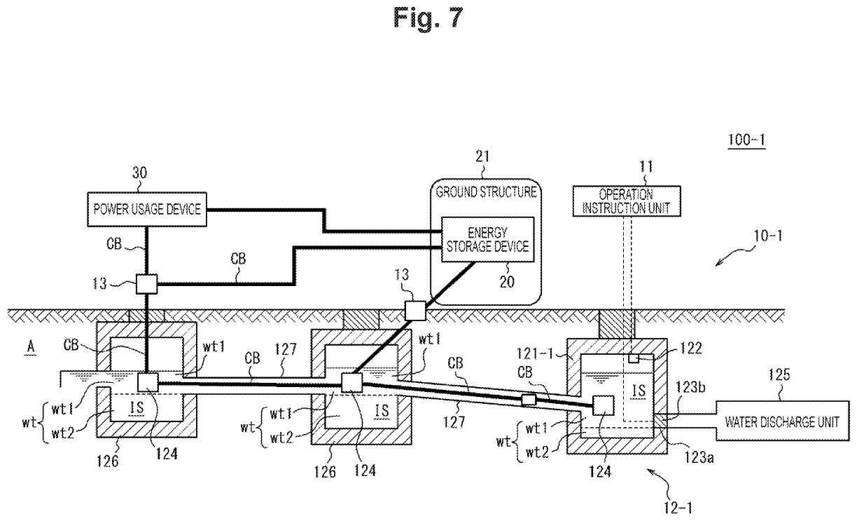

As illustrated in FIGS. 6 and 7, the power generation system 10-1 includes the operation instruction unit 11, a hydraulic power generation unit 12-1, and the power output unit 13.

The hydraulic power generation unit 12-1 includes the first water storage unit (first underground structure) 121-1, the water level detector 122, the water discharge controller 123, one or more power generation units 124, one or more second water storage units (second underground structure) 126, and a connection unit (pipeline) 127. The hydraulic power generation unit 12 may further include a water discharge unit 125. In the example illustrated in FIG. 6, the number of the second water storage units 126 included in the hydraulic power generation unit 12 is two, but is not limited thereto.

The first water storage unit 121-1 corresponds to the water storage unit 121 in the first embodiment.

As illustrated in FIG. 7, the second water storage unit 126 is a structure that is provided in the underground A and defines the internal space IS, similarly to the first water storage unit 121-1. The second water storage unit 126 is, for example, a manhole. The second water storage unit 126 is provided at a position higher than the first water storage unit 121-1.

Similarly to the first water storage unit 121-1, in some cases, water contained in the ground such as rainwater intrudes into the internal space IS of the second water storage unit 126 for some reason, whereby the water is retained in the internal space IS. In particular, the water wt is often retained in the internal space IS of the second water storage unit 126 provided in the underground A at a low altitude.

The connection unit 127 allows two or more water storage units among a plurality of water storage units including the first water storage unit 121-1 and one or more second water storage units 126 to communicate with each other. The connection unit 127 is an extending hollow structure. In the configuration in which the power generation system 10-1 includes a plurality of second water storage units 126, among the plurality of second water storage units 126, the second water storage units 126 provided at low positions may sequentially communicate with the first water storage units 121-1 via the connection units 127.

In the second embodiment, the power generation unit 124 generates electric energy from the hydraulic energy generated by discharge of the water wt as described in the first embodiment. In the second embodiment, the power generation unit 124 is disposed at a position where the water wt is retained in the internal space IS or the connection unit 127 communicating with the internal space IS.

As a result, the water wt retained in the second water storage unit 126 and the connection unit 127 moves to the second water storage unit 126 provided at a lower position, and moves to the first water storage unit 121-1 provided at a further lower position. Specifically, when the water discharge controller 123 provided in the first water storage unit 121-1 causes the water wt to be discharged from the first water storage unit 121-1, the water wt retained in the second water storage unit 126 moves toward the first water storage unit 121-1. At this time, the amount of water wt flowing into the first water storage unit 121-1 is the total amount of the movable retention water wt1 in the second water storage unit 126 and the water retained in the connection unit 127.

In addition, in the second embodiment, one or more power generation units 124 are disposed at positions where water is retained in any one or more of the first water storage unit 121-1, one or more second water storage units 126, and one or more connection units 127. As a result, each of the one or more power generation units 124 can generate electric energy by the water pressure associated with the water flow generated by the movement of the water due to the discharge of the water from the first water storage unit 121-1.

### <Operation of Power Generation System>

An operation of the power generation system 10-1 according to the second embodiment is similar to the operation of the power generation system 10 according to the second embodiment. However, in the operation of power generation system 10-1, in step S15, the power generation unit 124 each provided in any one or more of the first water storage unit 121-1, the connection unit 127, and the second water storage unit 126 generates electric energy.

As described above, the power generation system 10-1 according to the second embodiment further includes: one or more second water storage units 126 that are provided in the underground A, provided at positions higher than the first water storage units 121-1, and define the internal space IS; one or more connection units 127 that allow two or more of the plurality of water storage units including the first water storage unit 121-1 and the one or more second water storage units 126 to communicate with each other; and one or more power generation units 124. The one or more power generation units 124 are disposed at positions where water is retained in any one or more of the first water storage unit 121-1, the one or ore second water storage units 126, and the one or more connection units 127. As a result, the power generation system 10-1 can generate even greater electric energy than the power generation system 10.

### <Program>

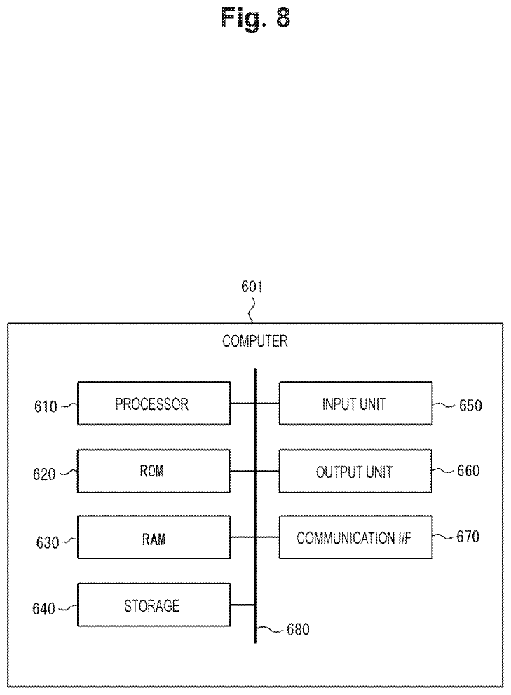

The operation instruction unit 11 described above can be implemented by a computer 601. In addition, a program for causing the computer to function as the operation instruction unit 11 may be provided. In addition, the program may be stored in a storage medium or may be provided via a network. FIG. 8 is a block diagram illustrating a schematic configuration of the computer 601 that functions as the operation instruction unit 11. The computer 601 may be a general-purpose computer, a dedicated computer, a workstation, a personal computer (PC), an electronic notepad, or the like. The program command may be a program code, a code segment, or the like for executing a necessary task.

As illustrated in FIG. 8, the computer 601 includes a processor 610, a read only memory (ROM) 620, a random access memory (RAM) 630, a storage 640, an input unit 650, an output unit 660, and a communication interface (I/F) 670. The components are communicably connected to each other via a bus 680. Specifically, the processor 610 is a central processing unit (CPU), a micro processing unit (MPU), a graphics processing unit (GPU), a digital signal processor (DSP), a system on a chip (SoC), or the like and may include a plurality of processors of the same or different types.

The processor 610 controls each component and executes various types of arithmetic processing. That is, the processor 610 reads a program from the ROM 620 or the storage 640 and executes the program by using the RAM 630 as a working area. The processor 610 performs control on the components and various types of arithmetic processing in accordance with the program stored in the ROM 620 or the storage 640. In the above embodiment, the program according to the present disclosure is stored in the ROM 620 or the storage 640.

The program may be stored in a storage medium that can be read by the computer 601. By using such a storage medium, it is possible to install the program in the computer 601. Here, the storage medium in which the program is stored may be a non-transitory storage medium. The non-transitory storage medium is not particularly limited, but may be, for example, a CD-ROM, a DVD-ROM, Or universal serial bus (USB) memory. In addition, the program may be downloaded from an external device via a network.

The ROM 620 stores various programs and various types of data. The RAM 630 temporarily stores a program or data as a working area. The storage 640 includes a hard disk drive (HDD) or a solid state drive (SSD) and stores various programs including an operating system and various types of data.

The input unit 650 includes one or more input interfaces that accept a user's input operation and acquire information based on the user's operation. For example, the input unit 650 is a pointing device, a keyboard, or a mouse, but is not limited thereto.

The output unit 660 includes one or more output interfaces that output information. The output unit 660 is a display that outputs information as video images, or a speaker that outputs information as sound, for example, but is not limited thereto. Note that, the output unit 660 also functions as the input unit 650 in a case where the output unit is a touch panel display.

The communication interface 670 is an interface for communication with an external device.

Regarding the embodiments described above, the following supplementary notes are further disclosed.

### [Supplementary Note 1]

A power generation system including:
the first underground structure provided in an underground and defining an internal space;
a water discharge facility that controls discharge of water retained in the internal space; and
a generator disposed at a position where the water is retained in the internal space or a pipeline communicating with the internal space, the generator that generates electric energy from hydraulic energy generated by discharge of the water.

### [Supplementary Note 2]

The power generation system according to supplementary note 1, further including:
a controller that determines whether or not a water level of the water retained in the underground structure is equal to or higher than a water level threshold, transmits a water discharge command for discharging water from the first underground structure to the water discharge facility if it is determined that the water level is equal to or higher than the water level threshold, and transmits a water discharge stop command for preventing water from being discharged from the first underground structure to the water discharge facility if it is determined that the water level is lower than the water level threshold, in which
the water discharge facility causes the water to be discharged from the first underground structure when receiving the water discharge command, and prevents the water from being discharged from the first underground structure when receiving the water discharge stop command.

### [Supplementary Note 3]

The power generation system according to supplementary note 2, in which the controller determines whether or not an electric energy amount, which is an amount of the electric energy generated by the generator, is increased when the water discharge facility is causing the water to be discharged from the first underground structure, transmits the water discharge command to the water discharge facility if it is determined that the electric energy amount is increased, and transmits the water discharge stop command to the water discharge facility if it is determined that the electric energy amount is not increased.

### [Supplementary Note 4]

The power generation system according to any one of supplementary notes 1 to 3, in which the water discharge facility includes a drain port provided in the first underground structure and a closing member that closes the drain port, causes the water to be discharged from the first underground structure by removal of the closing member from the drain port, and prevents the water from being discharged from the first underground structure by attachment of the closing member to the drain port.

### [Supplementary Note 5]

The power generation system according to any one of supplementary notes 1 to 4, further including:
one or more second underground structures provided in the underground, provided at a higher position than the first underground structure, and defining an internal space;
one or more pipelines that allow two or more of a plurality of underground structures including the first underground structure and the one or more second underground structures to communicate with each other; and
one or more of the generators, in which
one or more of the generators are disposed at positions where the water is retained in any one or more of the first underground structure, the one or more second underground structures, and the one or more pipelines.

### [Supplementary Note 6]

The power generation system according to any one of supplementary notes 1 to 5, further including a water discharge unit that accommodates the water discharged from the first underground structure.

### [Supplementary Note 7]

An energy storage system including:
the power generation system according to any one of supplementary notes 1 to 6; and
an energy storage device that stores the electric energy generated by the generator.

All documents, patent applications, and techniques described in the present specification are herein incorporated by reference to the same extent as if each individual document, patent application, and technique were specifically and individually described to be incorporated by reference.

Although the above embodiments have been described as representative examples, it is apparent to those skilled in the art that many modifications and substitutions can be made within the spirit and scope of the present disclosure. Accordingly, it should not be understood that the present invention is limited by the above-described embodiments, and various modifications or changes can be made without departing from the scope of the claims.

### REFERENCE SIGNS LIST

10, 10-1 Power generation system
11 Operation instruction unit
12, 12-1 Hydraulic power generation unit
13 Power output unit
20 Energy storage device
21 Ground structure
30 Power usage device
41 Steel tower
42 Communication office building
43 Communication facility
44 Cable tunnel
45 Bridge
46 Pipeline
47 Utility pole
48 Terminal box
51 Distribution member
52 Terminal box
100, 100-1 Energy storage system
121 Water storage unit (first underground structure)
121-1 First water storage unit (first underground structure)
122 Water level detector
123 Water discharge controller
123a Drain port
123b Closing member
124 Power generation unit
125 Water discharge unit
126 Second water storage unit (second underground structure)
127 Connection unit (pipeline)
601 Computer
610 Processor
620 ROM
630 RAM
640 Storage
650 Input unit
660 Output unit
670 Communication interface
680 Bus

1. A power generation system comprising:
a first underground structure provided in an underground and defining an internal space;
a water discharge controller configured to control discharge of water retained in the internal space; and
a power generation device disposed at a position where the water is retained in the internal space or a pipeline communicating with the internal space, the power generation device configured to generate electric energy from hydraulic energy generated by discharge of the water.

2. The power generation system according to claim 1, further comprising:
an operation instruction device configured to determine whether or not a water level of the water retained in the underground structure is equal to or higher than a water level threshold, transmit a water discharge command for discharging water from the first underground structure to the water discharge controller if it is determined that the water level is equal to or higher than the water level threshold, and transmit a water discharge stop command for preventing water from being discharged from the first underground structure to the water discharge controller if it is determined that the water level is lower than the water level threshold, wherein
the water discharge controller causes the water to be discharged from the first underground structure when receiving the water discharge command, and prevents the water from being discharged from the first underground structure when receiving the water discharge stop command.

3. The power generation system according to claim 2, wherein the operation instruction device determines whether or not an electric energy amount, which is an amount of the electric energy generated by the power generation device, is increased when the water discharge controller is causing the water to be discharged from the first underground structure, transmits the water discharge command to the water discharge controller if it is determined that the electric energy amount is increased, and transmits the water discharge stop command to the water discharge controller if it is determined that the electric energy amount is not increased.

4. The power generation system according to claim 1, wherein the water discharge controller includes a drain port provided in the first underground structure and a closing member that closes the drain port, causes the water to be discharged from the first underground structure by removal of the closing member from the drain port, and prevents the water from being discharged from the first underground structure by attachment of the closing member to the drain port.

5. The power generation system according to claim 1 further comprising:
one or more second underground structures provided in the underground, provided at a higher position than the first underground structure, and defining an internal space;
one or more pipelines configured to allow two or more of a plurality of underground structures including the first underground structure and the one or more second underground structures to communicate with each other; and
one or more of the power generation devices, wherein
one or more of the power generation devices are disposed at positions where the water is retained in any one or more of the first underground structure, the one or more second underground structures, and the one or more pipelines.

6. The power generation system according to claim 1, further comprising a water discharge device configured to accommodate the water discharged from the first underground structure.

7. An energy storage system comprising:
the power generation system according to claim 1; and
an energy storage device configured to store the electric energy generated by the power generation device.

8. The power generation system according to claim 1, wherein the generated electric energy is stored in a storage battery or in a fuel cell.

9. The power generation system according to claim 8, wherein a power usage device operates using electrical energy output from a power output device or from the storage battery.

10. A power generation method comprising:
a water level detection device that detects water level and determines the water level is equal to or higher than a water level threshold;
a drainage control device drains the water if the water level is higher than the water level threshold;
a power generation device generates electrical energy from hydroelectric energy accumulated in association with the drained water; and
an operation instruction device determines amount of electrical energy being generated by the power generation device is decreasing or increasing and stops water drainage if the amount of electrical energy being generated is decreasing.
